(19) United States
(12) Patent Application Publication
(10) Pub. No.: US 2017/0276303 A1
(43) Pub. Date: Sep. 28, 2017

(54) DETACHABLE SOLAR POWERED LAMP

(71) Applicant: Seksun Corporation Limited, Shenzhen (CN)

(72) Inventor: Songping Chen, Shenzhen (CN)

(21) Appl. No.: 15/413,533

(22) Filed: Jan. 24, 2017

(30) Foreign Application Priority Data
Mar. 24, 2016 (CN) 201620230379.X

(51) Int. Cl. F21L 4/08; F21V 7/00; F21V 17/10; F21V 23/04; F21V 23/00

(52) U.S. Cl. CPC F21L 4/08; F21V 23/0414; F21V 23/005; F21V 17/105; F21V 7/0083; F21V 17/108; F21V 17/104; F21V 17/16

(57) ABSTRACT

The present disclosure is directed towards a detachable solar powered lamp and a solar powered lamp assembly. The detachable solar powered lamp comprises a solar panel light assembly and a housing assembly. The solar panel light assembly comprises a printed circuit board, a rechargeable battery and the LEDs both positioned on the first side of the printed circuit board, a solar panel positioned on the second side of the printed circuit board, a top cover covering all the above on the first side of the printed circuit board and a switch for switching on and off the LEDs. The housing assembly includes a housing. The solar panel light assembly and the housing assembly can be detached and attached freely. The solar panel light assembly and the housing assembly are produced independently and can be freely matched, which is easy to manufacture and can be combined in various forms.

### CROSS-REFERENCE TO RELATED APPLICATIONS

This present invention claims the benefit of Chinese Patent Application No. CN201620230379.X, filed on Mar. 24, 2016, which is hereby incorporated by reference as its entirety.

### FIELD OF THE INVENTION

The present disclosure is directed to a detachable solar powered lamp and a solar powered lamp assembly.

### BACKGROUND OF THE INVENTION

Solar energy is a form of natural and pollution-free energy, solar energy is the preferred source of energy for many products, and is also commonly applied to many lighting products. The known solar powered lamps are not detachable, and in a single form.

### SUMMARY OF THE INVENTION

The invention is directed to a detachable solar powered lamp, in various forms.

The invention is achieved through the following technical solution: The detachable solar powered lamp comprises a solar panel light assembly and a housing assembly. The solar panel light assembly comprises a printed circuit board, a rechargeable battery, the LEDs, a solar panel, a top cover and a switch for switching on and off the LEDs. The rechargeable battery and the LEDs are both positioned on the first side of the printed circuit board, the solar panel is positioned on the second side of the printed circuit board, and the top cover covers all the above on the first side of the printed circuit board. The housing assembly includes a housing. The solar panel light assembly and the housing can be detached and attached freely.

A further improvement according to the above solution, wherein the ways of detaching and attaching freely are practiced as follows: the housing is provided with a top end and a bottom end on the opposite side, the bottom end includes an inner bottom and an outer bottom, the first set of magnetic attachments are set between the inner bottom and the outer bottom, the second set of magnetic attachments can be attached to the first set of magnetic attachments and are positioned on the solar panel light assembly. It shall be explained that, if the magnetic attachment in the invention is a magnet or a material with magnetic properties, then the corresponding attachment is also a magnet or a material with magnetic properties, or some materials that can easily attract magnets like ferromagnetic material. If the first set of attachments are magnets, then the second set of attachments are also magnets, and can also not be magnets but materials with iron properties, and vice versa. Moreover, the first set of magnetic attachments that are fixed between the inner bottom and the outer bottom by fusion heating or ultrasonic welding technology; the inner bottom and the outer bottom are made of plastic. The first set of magnetic attachments can be in various shapes, such as a thin round shape or square magnet with quantities of three or above, a thin iron piece or a plastic piece coupled with iron in the shape of a cross extending to the edge of the inner bottom, or a round disk with a hole in the middle to allow for the emission of the LED light. Correspondingly, the second set of magnetic attachments can also be of the same shape as the first set of magnetic attachments, as long as the first set of magnetic attachments and the second set of magnetic attachments can attract each other.

A further improvement according to the above solution, wherein the ways of detaching and attaching freely are practiced as follows: the housing is provided with a top end and a bottom end on the opposite side, the bottom end includes an inner bottom, an outer bottom and a bottom frame board, the bottom frame is set between the inner bottom and the outer bottom, the bottom frame board is provided with the first set of magnetic attachments, the solar panel light assembly is provided with the second set of magnetic attachments that can be attached to the first set of magnetic attachments.

A further improvement according to the above solution, wherein the bottom frame board is provided with the embedded hole or the embedded groove, the first set of magnetic attachments are positioned in the embedded hole or the embedded groove, the solar panel light assembly also includes an embedded board and a board with reflective cups positioned on the inner side of the top cover, the opening is provided on the embedded board for embedding the printed circuit board, the reflective cups are matched to the LEDs, the second set of magnetic attachments are bonded between the printed circuit board and the reflective cups.

A further improvement according to the above solution, wherein the ways of detaching and attaching freely are practiced as follows: The solar panel light assembly includes a cover body, the printed circuit board is fixed inside of the cover body, the top of the cover body is provided with the first threaded component; the housing is a rigid body, the housing is provided with the second threaded component can be attached to the first threaded component.

A further improvement according to the above solution, wherein the ways of detaching and attaching freely are practiced as follows: the solar panel light assembly includes a cover body, the printed circuit board is fixed inside of the cover body, the top of the cover body is provided with the first convex or the first concave; the housing is the rigid body, the housing is provided with the second concave or the second convex matching respectively to the first convex or the first concave. The numbers and quantities of the convex and the concave are set symmetrically, for example, four convex are positioned evenly, relative to the four concave that are also positioned evenly. Thus, the convex and the concave are to match each other and attach together correspondingly. Moreover, the convex and the concave can also be set continuously along the top of the cover body, which will form complete continuous and uninterrupted convex and concave, if the convex and concave are in a complete circle, they can attach to each other more tightly, and not be easily detached. Certainly, the above convex and concave that are set continuously can also not be completely continuous, and be cut off in the middle. It shall be explained that either way of setting the above convex and concave is aimed at ensuring the convex and concave can attach to each other, preventing the cover body from detaching from the housing. When the cover body and the housing are made from plastic, such as PVC, the convex or the concave can be made as a whole with the cover body or the housing accordingly, by using the injection molding machine or similar equipment in a single pass.

Basically on the same principle, the threads of the threaded component in the invention can be continuous and uninterrupted, or continuous and interrupted in the middle. Similarly, when the cover body and the housing are made of plastic, such as PVC, the threads can be made as a whole with the cover body or the housing, by using the injection molding machine or similar equipment.

A further improvement according to the above solution, wherein the ways of detaching and attaching freely are practiced as follows: The solar panel light assembly is connected to the housing assembly by means of Velcro, zipper, buckle clip or snap-fastener. Since the above ways of attachments are all achieved by matching the solar panel lighting assembly and the housing assembly to each other, the matching is in a fixed structure, a known technology, already available in the market, which will therefore not be listed. The Velcro, zipper, buckle clip or snap-fastener can be attached to the solar panel light assembly and the housing assembly by fusion heating or ultrasonic welding technology.

A further improvement according to the above solution, wherein the housing can be in the shape of a cylinder, cube, drum, vase, semi-sphere, football, pumpkin, bottle, can or sphere.

A further improvement according to the above solution, wherein a valve is provided on the housing for inflating the housing, and the housing is in the collapsible state when deflated. In other words, the valve is provided on the housing, when the housing is not inflated with air through the valve and the valve is opened, the housing can be completely compressed and collapsed, almost as a plane; When blowing air into the housing through the valve and pushing the valve back, the housing can be inflated and kept inflated.

The present invention is also directed to a solar powered lamp assembly, wherein the solar powered lamp assembly includes all the above detachable solar powered lamps, wherein the solar panel light assemblies are positioned at intervals either in a linear array or a circular array.

A further improvement according to the above solution, wherein the solar panel light assemblies are positioned in a linear array or a circular array. Certainly, the solar panel light assembly can also be in other geometric or aesthetic arrays, such as S array, etc.

The detachment function in the invention means that the solar panel light assembly and the housing are detachable, that is, the solar panel light assembly and the housing assembly are rigidly attached together, the solar panel light assembly and the housing assembly are independent, and then attached as a whole unit or complete product by freely detaching and attaching. The “ freely detaching” mean that the solar panel light assembly and the housing assembly can be easily detached and attached, according to their structure or the components, no special tools are required, and they can be easily detached and attached in a short time, without damaging any components.

It shall be explained that the LEDs can be arranged along the circumference, but not only limited to this, the LEDs can also be arranged in a square or oval or other geometric shape or other ways.

The benefit of this invention is that the solar panel light assembly and the housing assembly can be freely detached and attached, and the solar panel light assembly and the housing assembly are produced independently, which is easy to manufacture and can be combined in various forms. The solar panel light assembly can match with different housing assemblies. The solar panel light assembly can match with different colors of the housing assemblies, to achieve various lighting effects and decorative effects.

### BRIEF DESCRIPTION OF THE DRAWINGS

FIG. 1 is a view of detachable solar powered lamp according to the first shape in the detached status.

FIG. 2 is an exploded view of the housing of the first shape.

FIG. 2a is a view of another embodiment of the bottom frame board of the solar panel light assembly.

FIG. 2b is a view of another embodiment of bottom frame board of the solar panel light assembly.

FIG. 3 is a view of the detachable solar powered lamp according to the other embodiment in its detached state.

FIG. 4 is an exploded view of the solar panel light assembly of FIG. 3.

FIG. 5 is a stereoscopic view of the solar panel light assembly of the detachable solar powered lamp according to the various shapes.

FIG. 6 is a plan view of the solar panel light assembly of FIG. 5.

FIG. 7 is a stereoscopic view of the solar panel light assembly according to another shape.

FIG. 8 is a stereoscopic view of the housing of another shape.

FIG. 9 is a stereoscopic view of the housing of another shape.

FIG. 10 is a view of the detachable solar powered lamp after being assembled in another embodiment.

FIG. 11 is another view of the detachable solar powered lamp after being detached in another embodiment.

FIG. 12 is another view of the detachable solar powered lamp after being detached in another embodiment.

FIG. 13 is a stereoscopic view of the solar panel light assembly of FIG. 10.

FIG. 14 is a plan view of the solar panel light assemblies in a linear array.

FIG. 15 is a plan view of the solar panel light assemblies in a circular array.

### DETAILED DESCRIPTION OF ILLUSTRATED EMBODIMENTS

Hereafter combining the drawings of this invention, the technical solution in the embodiment will be described clearly and completely. Clearly, the described embodiments are only a part of the invention. The above assemblies in the description of the drawings and the embodiments may be combined with various forms and designs. Therefore, the detailed descriptions of the following embodiments are not intended to limit the protective scope of the invention, but serves as a reference to the selected embodiments. Based on these embodiments, all the other embodiments without any innovative efforts will also be under the protective scope of this invention.

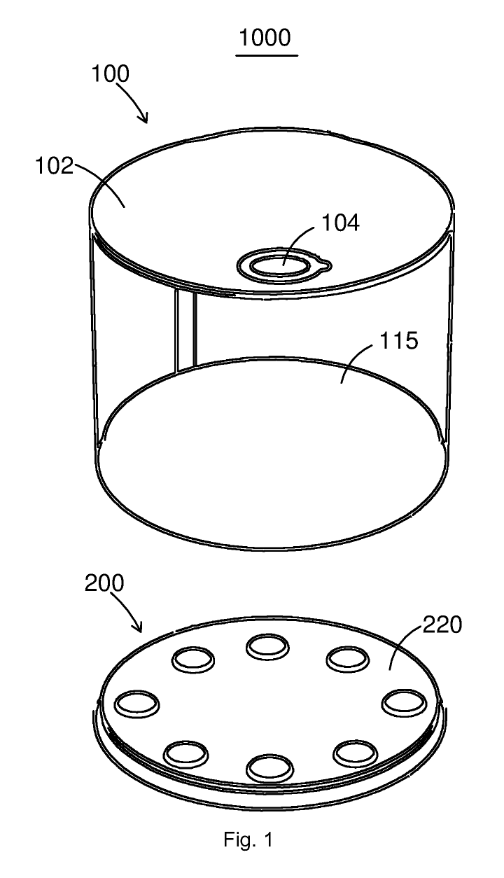

Referring to the embodiment of FIG. 1, a detachable solar powered lamp 1000 comprises the solar panel light assembly 200 and housing 100. Unlike existing technology where the solar panel light assembly and housing assembly are as a whole unit, the solar panel light assembly 200 and the housing 100 can be freely detached and attached.

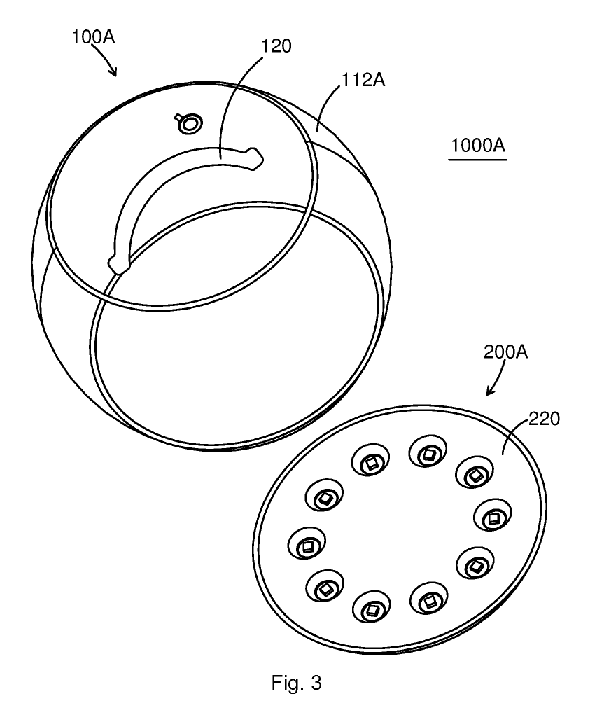

Referring to the embodiment of FIG. 4, the solar panel light assembly 200 comprises a printed circuit board 210, a rechargeable battery 212, the LEDs 214, a solar panel 228, a top cover 220 and a switch 224 for switching on and off the LEDs 214, the rechargeable battery 212 and the LEDs 214 are both positioned on the first side of the printed circuit board, the solar panel 228 is positioned on the second side of the printed circuit board, and the top cover 220 covers all the above on the first side of the printed circuit board 210.

The top end includes an inner top 110 and an outer top 102. A top reflector 106 is sealed between the inner top 110 and the outer top 102. The top reflector 106 is made with certain strength. A valve 104 is provided on the outer top 102, and connected to the housing 112 and an air chamber 114 through the first hole 108 on the top reflector 106 and the second hole (unmarked) on the inner top 110. It is generally preferred that the housing 112 is sealed to an ingress protection rating of IP67, which means being protected against the effects of temporary immersion in between 15 centimeters and 1 meters of water for 30 minutes. Referring to FIG. 4, the top reflector 106 has a reflective surface directly facing the LEDs 214, it can be made of reflective-coated PVC, reflective-coated paper card or other suitable reflective-coated materials.

The detachable solar powered lamp 1000 can be inflated by blowing air into the housing 112 through the valve 104 to form a certain shape, and deflated and collapsed by squeezing the air out of the housing 114 through the valve 104. The housing 112 can be made from soft, waterproof and translucent materials such as polyvinylchloride (PVC).

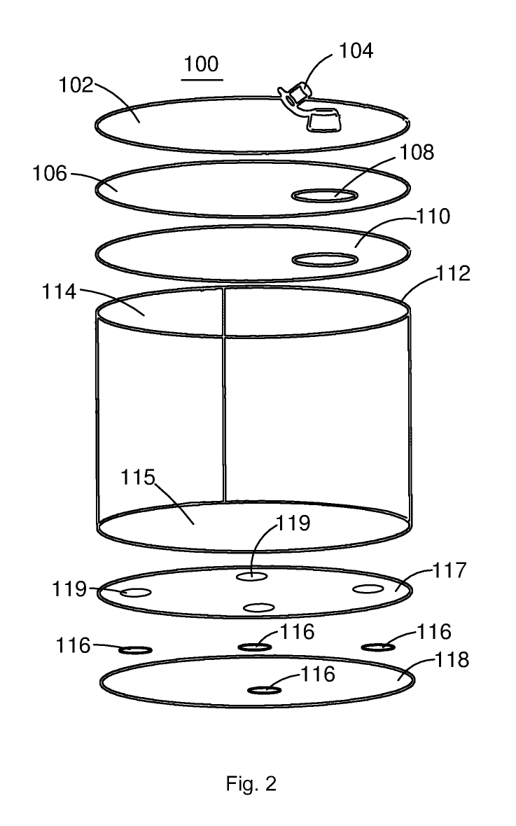

Referring to the embodiment of FIG. 2, the bottom end wall includes an inner bottom 115, a bottom frame board 117 and an outer bottom 118. The bottom frame 117 is sealed between the inner bottom 115 and the outer bottom 118. The bottom frame 117 can be translucent and made with certain strength, ensuring that the housing is a free-standing cylinder after being inflated. The first set of four magnets 116 are evenly positioned on the bottom frame board 117. The first set of four magnets 116 are attached to the second set of magnetic attachments 222 mentioned later. It shall be understood that the quantity of the first set of magnetic attachments 116 can be 1 or more.

Specifically, referring to the above embodiment of FIG. 2, the bottom frame board 117 is provided with the embedded holes 119. The first magnetic attachments 116 are positioned inside the embedded holes 119. Referring to the embodiment, there will be four embedded holes 119 correspondingly. The embedded holes are round through-holes. The first set of magnetic attachments 116 are positioned correspondingly one-to-one inside of the embedded holes 119.

Referring to the embodiment of FIG. 4, the solar panel light assembly 200 also includes an embedded board 206 and a panel board 216 with reflective cups 218 positioned on the inner side of the top cover, the opening 208 is provided on the embedded board 206 for embedding the printed circuit board 210, the reflective cup 218 are matched to the LEDs 214, the second set of magnetic attachments 222 are bonded between the printed circuit board 210 and the reflective cups 218. By means of the first set of magnetic attachments 116 and the second set of magnetic attachments 222 attracting each other, the solar panel light assembly and the housing assembly can be detached and attached freely. The solar panel light assembly and the housing assembly are produced independently and can be freely matched, which is easy to manufacture, and can be combined in various forms.

Referring to the embodiment of FIG. 2a, the bottom frame board 117A is provided with the embedded concave 119A, the embedded concave is in the form of a cross, the first set of magnetic attachments and the second set of magnetic attachments are also in the form of a cross correspondingly. Referring to the embodiment of FIG. 2b, the bottom frame board 117B is provided with the embedded concave 119B, the embedded concave is in the form of grids, the first set of magnetic attachments and the second set of magnetic attachments are also in the form of grids correspondingly. The artisan of ordinary skill in this field can easily understand that, the specific structure of the first set of magnetic attachments on the bottom frame board can be in various forms, which will not be solely listed here.

Referring to another embodiment, the bottom end includes an inner bottom, an outer bottom and a bottom frame board set between the inner bottom and the outer bottom. The first set of magnetic attachments that are positioned between the inner bottom and the outer bottom. The panel light assembly is provided with the second set of magnetic attachments that can be attached to the first set of magnetic attachments. For example, the first set of magnetic attachments is glued between the inner bottom and the outer bottom, the second set of magnetic attachments is glued on the printed circuit board. Alternatively, the first set of magnetic attachments is fixed between the inner bottom and outer bottom by being sandwiched between the inner bottom and the outer bottom. By means of the first set of magnetic attachments and the second set of magnetic attachments attracting to each other, the solar panel light assembly and the housing assembly can be freely detached and attached. As described above, the first set of magnetic attachments are fixed between the inner bottom and the outer bottom by fusion heating or ultrasonic welding technology, and that the inner bottom and the outer bottom are made of plastic

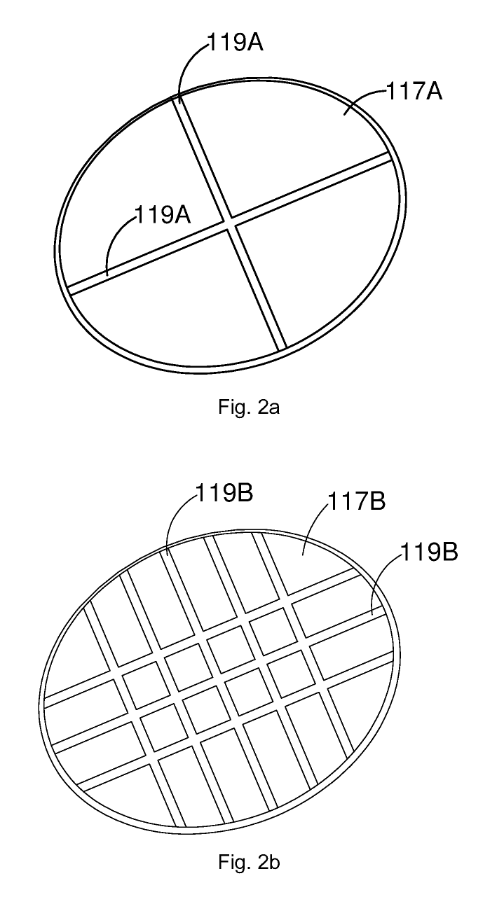

Referring to the embodiment of FIG. 3, the detachable solar powered lamp 1000A comprises the solar panel light assembly 200A and housing 100A. The solar panel light 200A and the housing 100A can be detached freely. In the second embodiment, a handle 120 is provided on the top end of the housing 100A. In the first embodiment described earlier, the housing 112 of the housing assembly 100 is in the shape of a cylinder, and in this second embodiment, the housing 112 of the housing assembly 100 is in the shape of a drum.

In the other embodiments, the housing can be in the shape of a vase, semi-sphere, cube, football, pumpkin, bottle, can or sphere. The housing assembly can also be in the shape of a cylinder, cube, drum, vase, semi-sphere, football, pumpkin, bottle, can or sphere. The solar panel light assembly and the housing assembly can be freely detached, and attached, thus the solar panel light assembly can be matched with different housing assemblies to form various solar powered lamps. The solar panel light assembly can be matched with different shapes of the housing assemblies; the solar panel light assembly can be matched with different colors of the housing assemblies, to achieve various lighting effects and decorative effects.

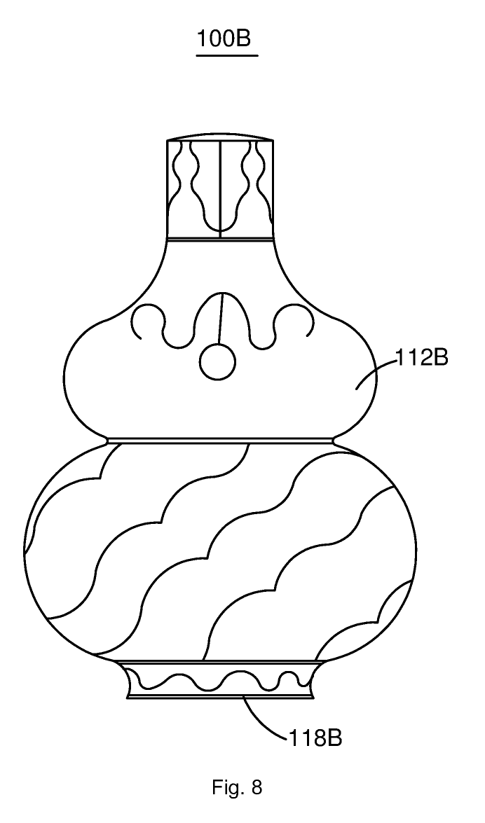

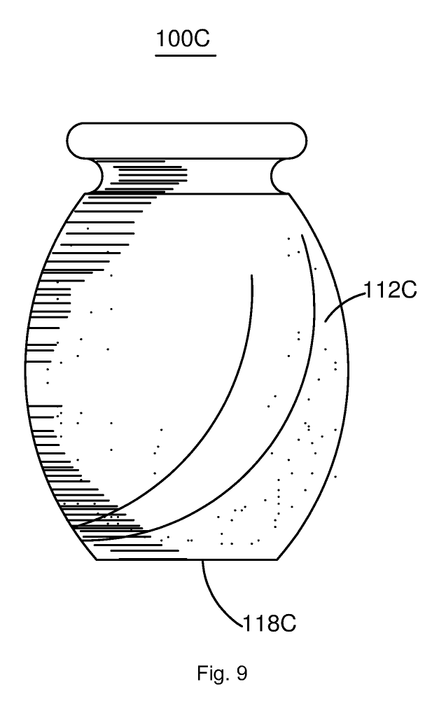

For example, referring to the condiments of FIG. 8, the housing assembly 100B is in the form of a vase-shape housing 112B, the outer bottom 118B can be attached to the solar panel light. Referring to the embodiment of FIG. 9, the housing 100C is in the form of a jar-shape housing 112C, the outer bottom 118C can be attached to the solar panel light assembly.

Referring to the embodiments of FIG. 4 to FIG. 7, the solar panel light assembly 200 comprises a printed circuit board 210, a rechargeable battery 212, the LEDs 214, a solar panel 228, a top cover 220 and a switch 224 for switching on and off the LEDs 214, the rechargeable battery 212 and the LEDs 214 are both positioned on the first side of the printed circuit board, the solar panel 228 is positioned on the second side of the printed circuit board, and the top cover 220 covers all the above on the first side of the printed circuit board 210.

As described above, the solar panel light assembly 200A and the housing assembly 100A can be detached and attached freely, in other words, the solar panel light assembly 200A and the housing 112A can be detached. In the embodiment, the top cover 220 can completely cover the first side and second side of the printed circuit board 210. In the embodiment, the solar panel light assembly 200A of the detachable solar powered lamp 1000A includes a panel board 216 with reflective cups 218 positioned on the inner side of the top cover 220A, matching to the LEDs 214. Furthermore, in the embodiment, the solar panel light assembly 200A comprises a bottom frame board 206, which is with an opening 208 attached to the printed circuit board 210. A handle 202A is provided on the top cover 220.

Referring to the embodiment of FIG. 4, the first side of printed circuit board 210 has the second set of four magnets 222, the first set of four magnets 116 are magnetically attracted to the second set of four magnets 222 correspondingly, as described above.

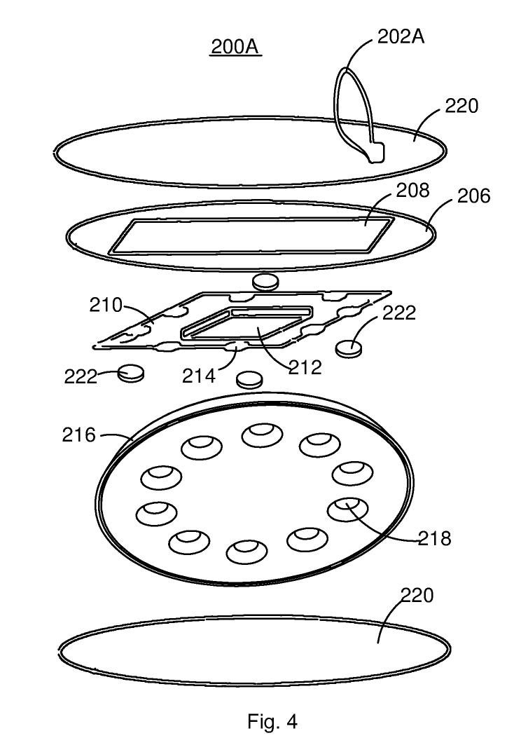

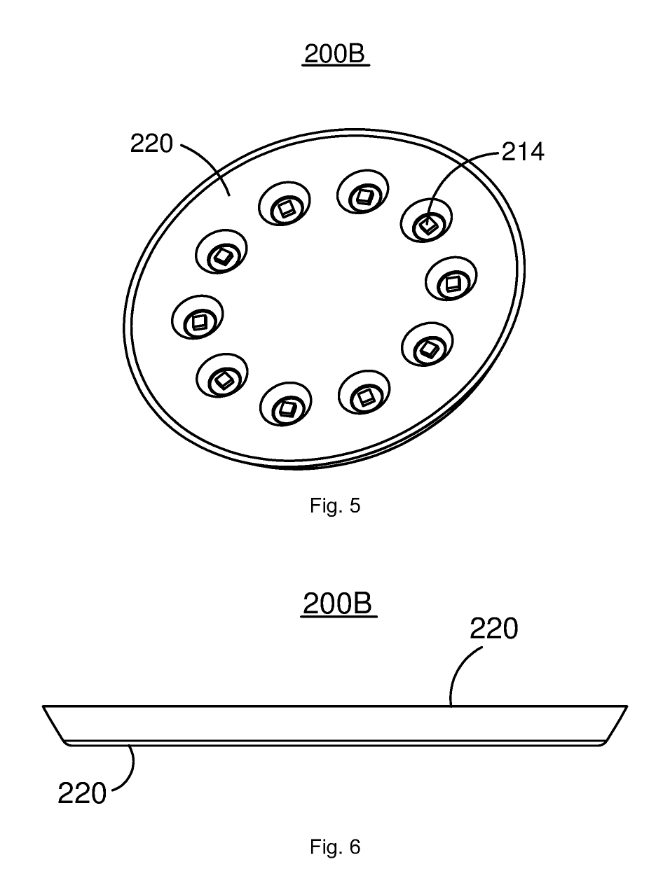

Referring to the embodiment of FIG. 5 to FIG. 6, the top cover 220 of the solar panel light assembly 200B can completely cover the first side and second side of the printed circuit board 210, forming a flat board shape, which is easy to manufacture, assemble, ship and carry.

In the other embodiments, the ways of detaching and attaching freely are practiced as follows: The solar panel light assembly is attached to the housing assembly by means of Velcro, zipper, buckle clip or snap-fastener. The artisan of ordinary skill in this field can easily think of other ways of attaching and detaching the solar panel assembly to the housing assembly, which will not be solely listed here, all the methods of attachments are within the protective scope of this invention.

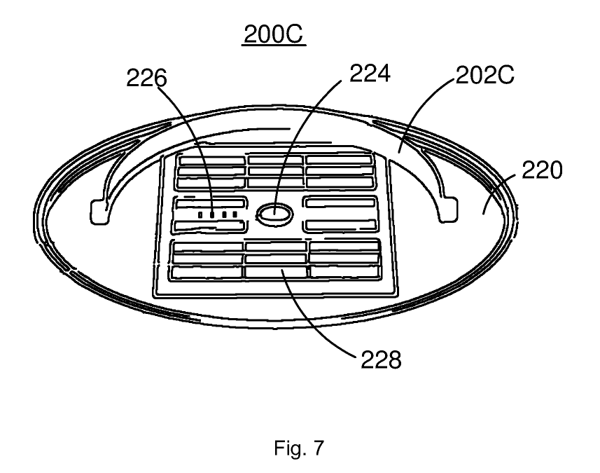

Referring to the embodiment of FIG. 7, a handle 202C is provided on the top cover 220 of the solar panel light assembly 200C, to permit the solar powered lamp to be easily attached.

Furthermore, referring to the embodiment of FIG. 7, the four battery power indicators 226 are provided on the solar panel light assembly 200C, which are connected to the printed circuit board 210. Four battery indicators are laid out in a straight line. Four battery power indicators will display as 20%, 50%, 75%, or 100% when pressing and holding the switch. For example, one indicator lights up when the battery power is less than 20%, two indicators light up when the battery power is between 20%˜50%, three indicators light up when the battery power is between 50%˜70%, four indicators light up when the battery power is between 75%˜100%. Comparing to similar inflatable solar-powered lamps, the detachable solar powered lamp is easy to use, consumers can know the battery status by looking at the battery power indicators. Furthermore, the battery power indicators can also be used as charging indicators, the battery power indicators will flash in a row during charging, and stop flashing when fully charged. The battery power indicator can be controlled by means of the power saving circuitry embedded in the printed circuit board, or hardware electrical circuit. In the embodiment, the battery power indicators will light up according to the battery power when pressing and holding the switch 34 for more than three seconds, as described above.

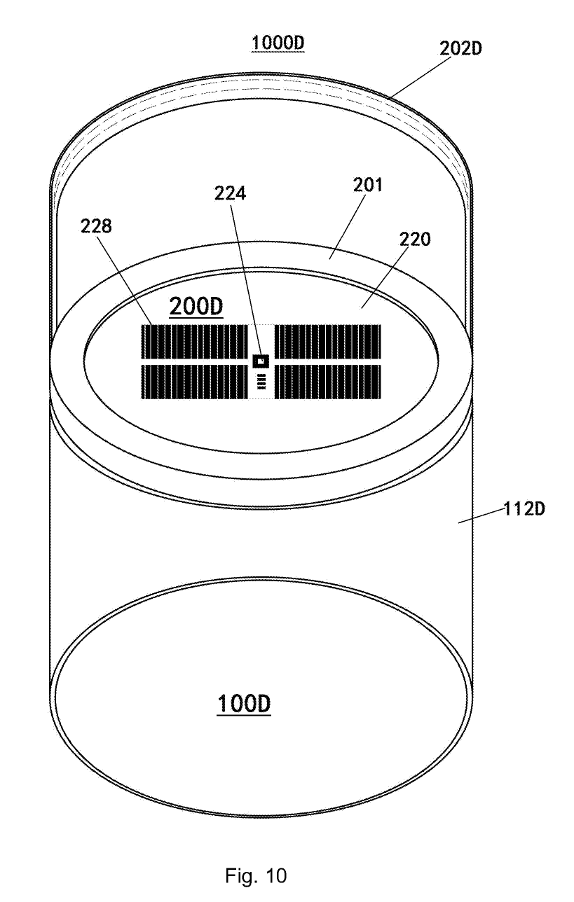

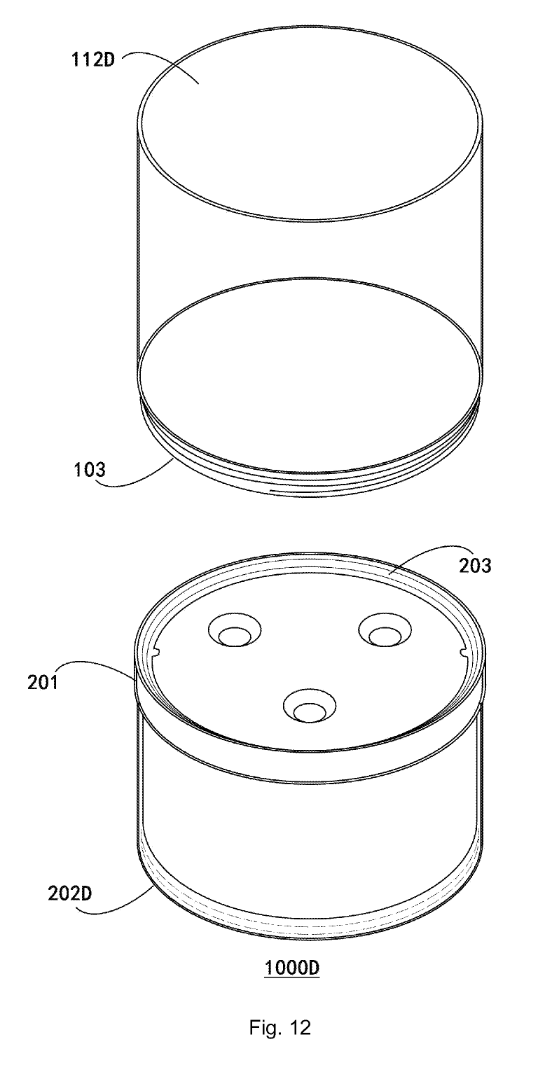

Referring to the embodiments of FIG. 10 to FIG. 13, the detachable solar powered lamp comprises the solar panel light assembly 200D and the housing assembly 100D. The solar panel light assembly 200D and the housing assembly 100D can be detached and attached freely. The housing 112D of the housing assembly 100D is a rigid body. It shall be explained that, comparatively speaking, the housing is a rigid body, it does not mean that the housing is completely rigid, not flexible or completely deformed. Relative to the soft inflatable housing 112 of the embodiment 1, the housing 112D is a rigid body, the housing 112D of the housing assembly 100D can be of certain flexibility, and as such it can be made from transparent plastic materials with certain thicknesses.

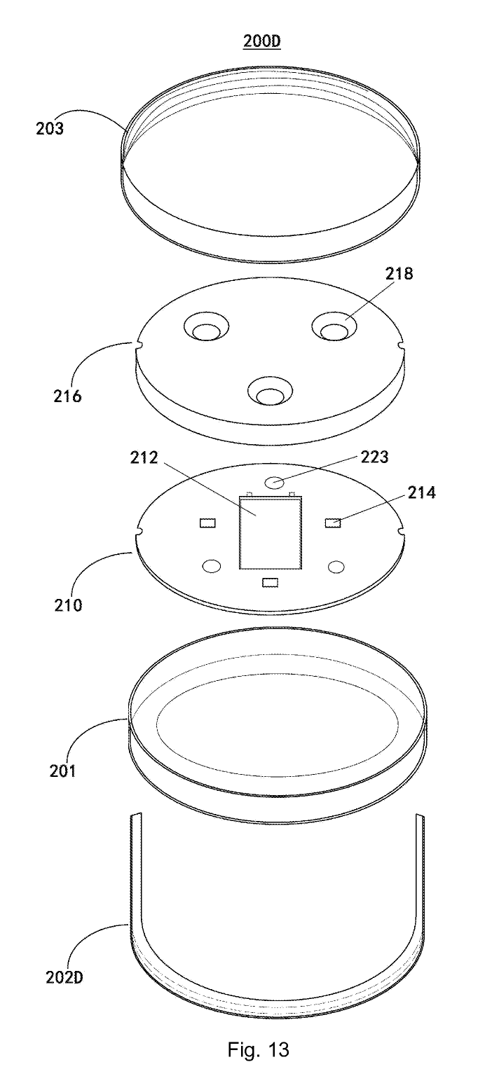

Referring to the embodiments of FIG. 10 to FIG. 13, the solar panel light assembly 200D includes a cover body. Referring to the embodiment of FIG. 13, a handle 202D is provided on the cover body 201. The printed circuit board 210 is fixed inside of the cover body 201. Referring to the embodiment of FIG. 13, the inner wall of the cover body 201 is provided with the first threaded component 203; the housing 112D is provided with the second threaded component attaching to the first threaded component. In the embodiment of FIG. 13, the first threaded component 203 is the internal thread; the second threaded component 103 is the external thread. It shall be easy to understand, that the first threaded component 203 is the internal thread; the second threaded component 103 is the external thread. In the embodiment, the top cover (unmarked) completely covers the first side and the second side of the printed circuit board 210, the solar panel light assembly 200D also includes a panel board 216 with reflective cups 218 positioned on the inner side of the top cover, the reflective cups 218 are matched to the LEDs 214, many magnetic attachments 223 are positioned on the first side of the printed circuit board 210. Therefore, the solar panel light assembly 200D can be freely combined with all kinds of housing assemblies. For example, the solar panel light assembly 200D can match to the rigid housing assembly 100D with threads, and can also match to the soft inflatable housing 100, 100A without threads. The solar panel light assembly and the housing assembly are produced independently and can be freely matched, which is easy to manufacture and can be combined in various forms.

In another embodiment, the solar panel light assembly includes a cover body, the printed circuit board is fixed inside of the cover body, the top of the cover body is provided with the first convex or the first concave; the housing is the rigid body, the housing is provided with the second concave or the second convex matching to the first convex or the first concave respectively. And the top end of the first convex or the second concave is provided with an undercut. Or an interference fit is applied between the convex and concave. Therefore, by attaching the convex and the concave, the solar panel light assembly and the housing assembly can be detached and attached freely.

In the embodiment, the solar panel light assembly and the housing assembly are produced independently and can be freely matched, which is easy to manufacture and combine in various forms. The solar panel light assembly can be matched with different housing assemblies. The solar panel light assembly can be matched with different colors of the housing assemblies, to achieve various lighting effects and decorative effects. If the LEDs are of different colors, such as the blue light, red light etc., the solar powered lamp will provide an overall dreamy colorful effect.

In another aspect of the invention, the present disclosure is directed to a solar powered lamp assembly, which is provided with many detachable solar powered lamp as described above, many solar panel light assemblies and many housing assemblies can detached and attached freely, can be freely exchanged, with various forms.

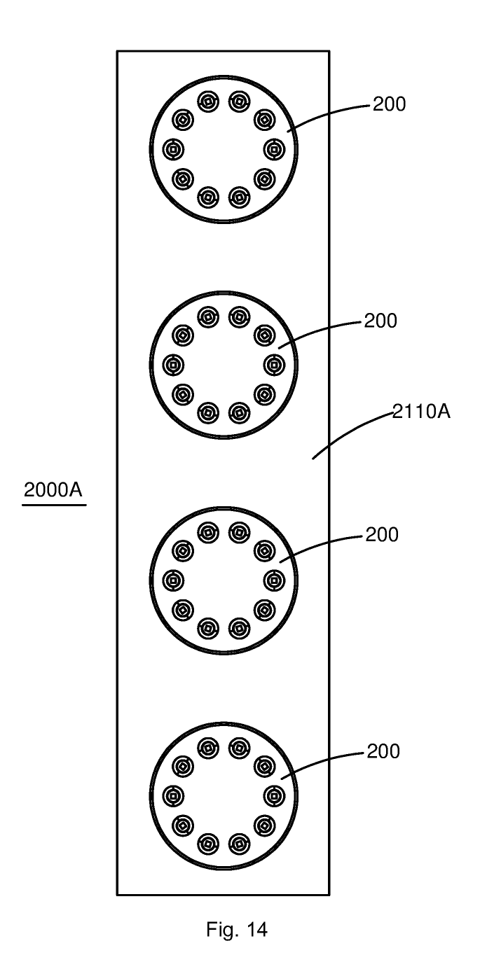

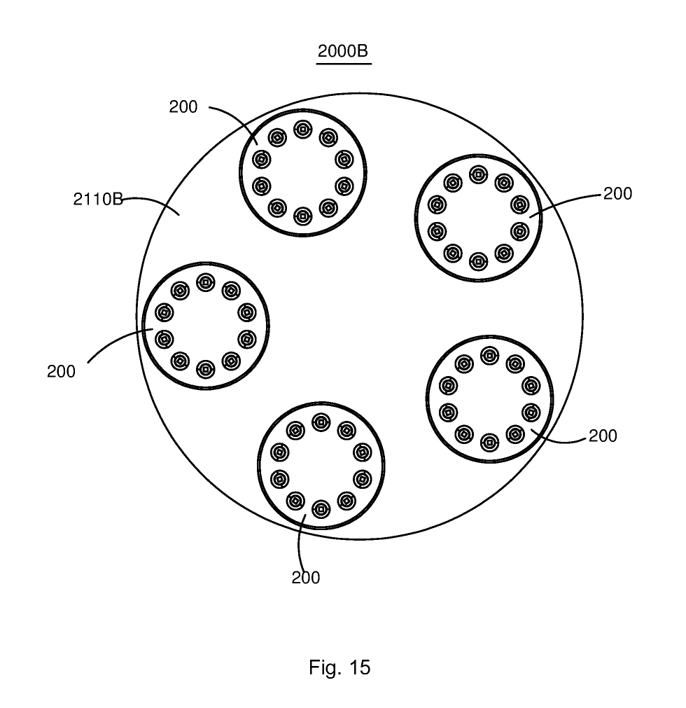

Referring to the embodiments of FIG. 14 and FIG. 15, the solar panel light assemblies 2000A and 2000B include multiple solar panel light assemblies 200 and housing assemblies (unmarked). These solar panel light assemblies 200 are lined up together. Referring to the embodiment of FIG. 10, the four solar panel light assemblies 200 are connected in the linear array on the connecting body 2110A. Therefore, the four solar panel light assemblies 200 can be freely matched with different shapes of housing assemblies according to specific circumstances, for example, the housing assemblies can be in the shape of a cylinder, cube, drum, vase, semi-sphere, football, pumpkin, bottle, can or sphere. The solar panel light assemblies can be matched with different colors of the housing assemblies, and can be easily changed, to achieve various lighting effects and decorative effects.

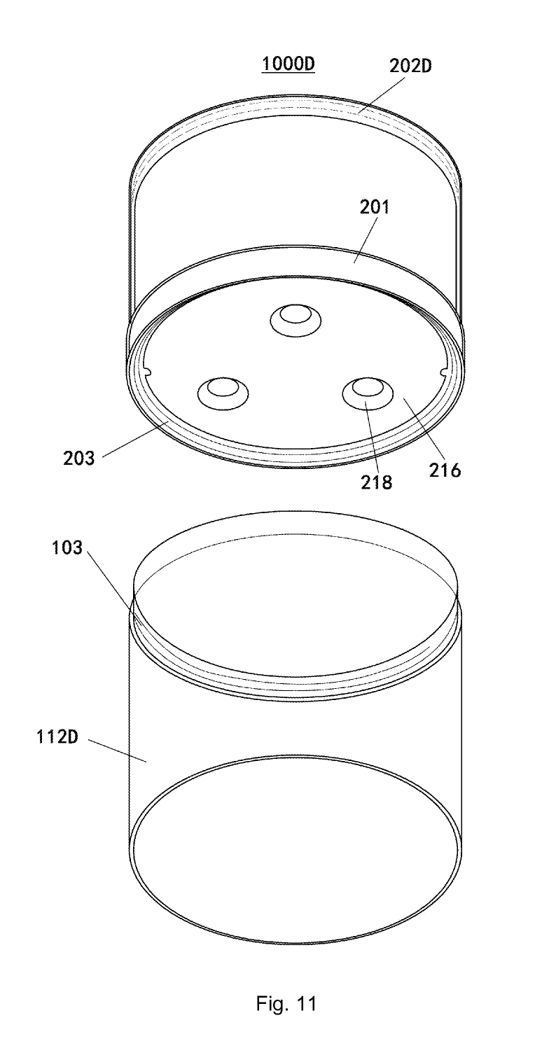

Additionally, referring to the embodiment of FIG. 11, the five solar panel light assemblies 200 are connected in the linear array on the connecting body 2110B. Therefore, the five solar panel light assemblies 200 can be freely matched to different shapes of housing assemblies according to specific circumstances, for example, the housing assemblies can be in the shape of a cylinder, cube, drum, vase, semi-sphere, football, pumpkin, bottle, can or sphere. The solar panel light assembly can be matched with different colors of the housing assemblies, and can be easily changed, to achieve various lighting effects or decorative effects.

The artisan of ordinary skill in the field can understand that the ways of arranging the solar panel light assembly can be in various forms, such as the S shape and the frame shape, according to specific circumstances. The housing assemblies connected to the solar panel light assembly can also be freely changed, to achieve different lighting effects or decorative effects.

The solar panel light assembly and housing of the detachable solar powered lamp in this invention can be freely matched, suitable for DIY creativity and decorations, and setting for different lighting environment, it is suitable for a wide range of promotional activities and application.

LEDs of high luminance are used in the solar panel light assembly of the invention, providing high brightness. Six hours of solar charge provides eight to ten hours of lighting. This is an extremely highly practical solar powered lamp, which is used in areas where there is sufficient sunlight. The solar powered lamp is great for use as home decorations, outdoor traveling, camping, adventure outing, or simply for normal lighting, emergency lighting, signage lighting and environmental lighting, etc.

With reference to the descriptions of this invention, the terms “first” and “second” shall only be understood for descriptive purposes, and shall not be understood as indicating or implying the importance. With reference to the descriptions of this invention, the terms “connected” or “attached” shall be understood as general meaning, for example, “ attach” or “ connect ” can be understood as fixed attachment, detachable connection or whole connection, or mechanical connection, electrical connection, or direct connection, connection by means of an intermediate media. For artisan of ordinary skill, all the above terms can be understood as specific meanings. Furthermore, regarding the descriptions in this invention, the term “multiple” shall be understood as two or more unless otherwise stated.

Although the embodiments of the present invention have been shown and described, the artisan of ordinary skill can understand as follows: the above embodiments can be applied with various changes, modifications, substitutions and variants without departing from the principles and objectives of the present invention. And the scope of the present invention is defined by the claims and their equivalents.

What is claimed is:

1. A detachable solar powered lamp, wherein the detachable solar powered lamp comprises a solar panel light assembly and a housing assembly; the solar panel light assembly comprises a printed circuit board, a rechargeable battery, the LEDs, a solar panel, a top cover and a switch for switching on and off the LEDs; the rechargeable battery and the LEDs are both positioned on the first side of the printed circuit board, the solar panel is positioned on the second side of the printed circuit board, and the top cover covers all the above on the first side of the printed circuit board; the housing assembly includes a housing; the solar panel light assembly and the housing can be detached and attached freely.

2. The detachable solar powered lamp according to claim 1, wherein the ways of detaching and attaching freely are practiced as follows:
the housing is provided with a top end and a bottom end on the opposite side, the bottom end includes an inner bottom and an outer bottom, the first set of magnetic attachments are set between the inner bottom and outer bottom, the second set of magnetic attachments that can be attached to the first set of magnetic attachments are positioned on the solar panel light assembly.

3. The detachable solar powered lamp according to claim 1, wherein the ways of detaching and attaching freely are practiced as follows:
the housing is provided with a top end and a bottom end on the opposite side, the bottom end includes an inner bottom, an outer bottom and a bottom frame board set between the inner bottom and the outer bottom, the bottom frame board is provided with the first set of magnetic attachments, the solar panel light assembly is provided with the second set of magnetic attachments that can be attached to the first set of magnetic attachments.

4. The detachable solar powered lamp according to claim 3, wherein the bottom frame board is provided with the embedded hole or the embedded groove, the first set of magnetic attachments are positioned inside the embedded hole or the embedded groove, the solar panel light assembly also includes an embedded board and a board with reflective cups that are positioned on the inner side of the top cover, the opening is provided on the embedded board for embedding the printed circuit board, the reflective cups are matched to the LEDs, the second set of magnetic attachments are bonded between the printed circuit board and the reflective cups.

5. The detachable solar powered lamp according to claim 1, wherein the ways of detaching and attaching freely are practiced as follows:
the solar panel light assembly includes a cover body, the printed circuit board is fixed inside of the cover body, the top of the cover body is provided with the first threaded component; the housing is a rigid body, the housing is provided with the threaded component attaching to the first threaded component.

6. The detachable solar powered lamp according to claim 1, wherein the ways of detaching and attaching freely are practiced as follows:
the solar panel light assembly includes a cover, the printed circuit board is fixed inside of the cover, the top of the top cover is provided with the first convex or the first concave; the housing is the rigid body, the housing is provided with a corresponding second concave or the second convex matching to the first convex or the first concave respectively.

7. The detachable solar powered lamp according to claim 1, wherein the ways of detaching and attaching freely are practiced as follows:
the solar panel light assembly is attached to the housing assembly by means of Velcro, zipper, buckle clip or snap-fastener.

8. The detachable solar powered lamp according to claim 1, wherein the housing can be in the shape of a cylinder, cube, drum, vase, semi-sphere, football, pumpkin, bottle, can or sphere.

9. The detachable solar powered lamp according to claim 1, wherein a valve is provided on the housing for inflating the housing, and the housing is in the collapsible state when deflated.

10. A solar powered lamp assembly, wherein the detachable solar powered lamp comprises a solar panel light assembly and a housing assembly; the solar panel light assembly comprises a printed circuit board, a rechargeable battery, the LEDs, a solar panel, a top cover and a switch for switching on and off the LEDs; the rechargeable battery and the LEDs are both positioned on the first side of the printed circuit board, the solar panel is positioned on the second side of the printed circuit board, and the top cover covers all the above on the first side of the printed circuit board; the housing assembly includes a housing; the solar panel light assembly and the housing can be detached and attached freely; wherein the solar panel light assembly of the detachable solar powered lamp are positioned at intervals either in a linear array or a circular array.

11. The solar powered lamp assembly according to claim 10, wherein the ways of detaching and attaching freely are practiced as follows:
the housing is provided with a top end and a bottom end on the opposite side, the bottom end includes an inner bottom and an outer bottom, the first set of magnetic attachments are set between the inner bottom and outer bottom, the second set of magnetic attachments that can be attached to the first set of magnetic attachments are positioned on the solar panel light assembly.

12. The solar powered lamp assembly according to claim 10, wherein the ways of detaching and attaching freely are practiced as follows:
the housing is provided with a top end and a bottom end on the opposite side, the bottom end includes an inner bottom, an outer bottom and a bottom frame board set between the inner bottom and the outer bottom, the bottom frame board is provided with the first set of magnetic attachments, the solar panel light assembly is provided with the second set of magnetic attachments that can be attached to the first set of magnetic attachments.

13. The solar powered lamp assembly according to claim 12, wherein the bottom frame board is provided with the embedded hole or the embedded groove, the first set of magnetic attachments are positioned inside the embedded hole or the embedded groove, the solar panel light assembly also includes an embedded board and a board with reflective cups that are positioned on the inner side of the top cover, the opening is provided on the embedded board for embedding the printed circuit board, the reflective cups are matched to the LEDs, the second set of magnetic attachments are bonded between the printed circuit board and the reflective cups.

14. The solar powered lamp assembly according to claim 10, wherein the ways of detaching and attaching freely are practiced as follows:
The solar panel light assembly includes a cover body, the printed circuit board is fixed inside of the cover body, the top of the cover body is provided with the first threaded component; the housing is a rigid body, the housing is provided with the threaded component attaching to the first threaded component.

15. The solar powered lamp assembly according to claim 10, wherein the ways of detaching and attaching freely are practiced as follows:
the solar panel light assembly includes a cover, the printed circuit board is fixed inside of the cover, the top of the top cover is provided with the first convex or the first concave; the housing is the rigid body, the housing is provided with a corresponding second concave or the second convex matching to the first convex or the first concave respectively.

16. The solar powered lamp assembly according to claim 10, wherein the ways of detaching and attaching freely are practiced as follows:
the solar panel light assembly is attached to the housing assembly by means of Velcro, zipper, buckle clip or snap-fastener.

17. The solar powered lamp assembly according to claim 10, wherein the housing can be in the shape of a cylinder, cube, drum, vase, semi-sphere, football, pumpkin, bottle, can or sphere.

18. The solar powered lamp assembly according to claim 10, wherein a valve is provided on the housing for inflating the housing, and the housing is in the collapsible state when deflated.
